(19) United States
(12) Patent Application Publication
(10) Pub. No.: US 2009/0193869 A1
(43) Pub. Date: Aug. 6, 2009

(54) Metal blank for container bodies

(76) Inventors: David Gaensbauer, Kingston (CA); David Andrew Gill, Naperville, IL (US)

Correspondence Address: Christopher C. Dunham,;c/o Cooper & Dunham LLP, 1185 Ave., New York, NY, 10036, US

(21) Appl. No.: 12/012,817

(22) Filed: Feb. 5, 2008

(51) Int. Cl. B21D 22/00; B23P 11/00; B65D 85/62

(52) U.S. Cl. 72/348; 29/430; 206/519

(57) ABSTRACT

Exemplary embodiments of the invention relate to a container blank of defined shape, a method of feeding the blanks, and apparatus for feeding the blanks. The blanks are shaped or contoured in such a way that mutual adhesion between the blanks of a nested stack of such blanks can be broken, thus facilitating the delivery of individual blanks from the stack. The shaping of the blanks is effective to cause the blanks to separate from each other or to tilt mutually by a small distance when one blank is moved at approximately right angles to the stack. This allows ingress of air between the blanks that eliminates the mutual adhesion.

### BACKGROUND OF THE INVENTION

I. Field of the Invention

This invention relates to the production of container bodies made of metal from pre-formed metal blanks. More particularly, the invention relates to the design of such metal blanks and to their use.

II. Background Art

Beverage container bodies are generally produced in two forming steps carried out in different machines. The first step involves cutting a flat circular blank from a flat sheet of metal and creating a shallow cup from the blank in a drawing operation. The second step involves reducing the cup diameter and thinning and elongating the sides of the cup to produce a full-length container body by redrawing and ironing operations or other steps. Ironing involves passing the redrawn cup (supported on a punch, mandrel or the like) through a number of dies or rings of progressively smaller diameter to thin and stretch the sidewalls of the container body. The container body is then normally trimmed and shaped at the open end and provided with a closure in the form of a generally flat container lid or end wall. The metal for the container bodies is normally supplied to the fabricator in the form of a metal coil or roll and the fabricator stamps circular flat metal pieces or blanks from the metal roll as part of the overall container body forming operation. This produces a significant amount of metal waste in the form of a flat web with punched-out circular holes. The metal waste is normally returned to the metal supplier for recycling, but this is an inefficient procedure because it involves transporting a certain percentage of metal first to the fabricator and then from the fabricator back to the metal supplier. In circumstances where the metal fabricator and the container body producer are resident in different countries, some governments apply taxes or duties on both metal sheet imports and scrap metal exports, thus further reducing the economic benefit of supplying the metal in the form of continuous sheet.

It is therefore desirable to supply the container body fabricator with pre-formed metal blanks rather than rolled metal sheet, and machinery has been developed to accept such metal blanks as a starting material (see, for example, U.S. patent application Ser. No. 11/975,926, filed Oct. 22, 2007, the disclosure of which is incorporated herein by reference). Nevertheless, difficulties can be encountered during the process of feeding such blanks to machinery of this kind. In particular, if flat metal blanks are stacked together prior to being fed to the machinery, they have a tendency to stick together, especially when provided with a thin coating of oil, wax or other material (which is a common practice to protect the surface and to mitigate oxidation). This is due to air pressure (attempted separation of blanks can create a temporary vacuum between intimately contacting parts) and/or surface tension (when a liquid or semi-solid is present between adjacent blanks). This can lead to improper delivery of the blanks to the apparatus, especially when automated blank-feeding equipment is employed, resulting in delays or stoppages.

Attempts to deal with problems of handling metal blanks have been made in the past. For example, U.S. Pat. No. 2,088,329 issued on Jul. 27, 1937 to MacCordy for a metal blank and a method of feeding the blank. This patent is concerned with the difficulty of feeding relatively thin and easily bendable metal blanks, such as those made from metal foil and the like (e.g. those of 0.003 inch in thickness, which is thinner than blanks typically used for making metal container bodies). The solution provided by this patent is to provide the blanks with oppositely projecting series of ridges that prevent nesting of the blanks and thus provide blanks that remain somewhat separated at their edges when stacked. This provides the feeding apparatus with a larger target for the feeding apparatus that pushes the blanks, one at a time, from the stack. The shape adopted may be designed to facilitate the passage of one blank across the next in the feeding operation so that the blanks do not bind against each other. The avoidance of nesting helps to prevent the blanks from sticking together, but increases the bulk of a stack of the blanks, and decreases the stability of a stack, to the detriment of shipping and handling prior to use.

U.S. Pat. No. 3,636,608 which issued on Jan. 25, 1972 to Thompson discloses a shaped metal blank used as an attachment for forming a protective edge on a container. The blank has a protrusion on one side to prevent contact between the main parts of adjacent blanks as they are stacked together. The purpose of this is to prevent frictional drag as the blanks are moved relative to each other that could cause feeding apparatus to malfunction. Again, this invention prevents full nesting of the blanks, and thus increases the bulk of a stack of the blanks.

There is therefore a need for an improved way of handling and feeding metal beverage container blanks that overcomes at least some of the disadvantages mentioned above, especially mutual adhesion adhesion between the blanks when stacked together.

### SUMMARY OF THE INVENTION

An exemplary embodiment provides a metal blank for conversion into a container body preferably by metal drawing and ironing procedures. The blank is made of a sheet of metal preferably of constant thickness having a peripheral region adjacent a periphery of the sheet and an inner region surrounded by the peripheral region. The inner region has at least one deformation forming a projection on one side of the sheet and a correspondingly-shaped depression in an opposite side of the sheet, the projection and depression being inwardly ramped at least around edges thereof. When the blank is tightly nested with an identical blank, the projection of one blank extends partially into the depression of the other blank sufficiently to allow parts of the blanks to experience mutual adhesion caused by air pressure or surface tension despite existence of a narrow gap between the peripheral regions of the blanks. Relative sideways motion of the blanks causes the blanks to tilt or move further apart due to engagement of the ramped projection and depression, thereby increasing the gap sufficiently to break the mutual adhesion between the blanks.

The blank is preferably circular, with a single projection that is preferably dome shaped, and the peripheral regions may be, for example, completely planar, partially planar including a ramped part, or completely ramped. The blank may be coated with a material that increases the mutual adhesion.

Generally, the projection is inwardly ramped around said edges at an angle of up to 60 degrees. The thickness of the blank is preferably in a range of greater than 0.003 inches and is preferably made of steel or alloys of aluminum.

Most preferably, the deformation is dome shaped and has dimensions effective to form an inwardly-cupped bottom wall of a container body after the blank undergoes metal drawing and ironing procedures effective to convert the peripheral regions of the blanks to walls of a container body.

Another exemplary embodiment provides a metal blank for conversion into a container body by metal drawing and ironing procedures. The blank comprises a sheet of metal having one or more planar regions and one or more non-planar regions, the sheet being nestable with identical blanks to form a nested stack of the blanks with parts in mutual contact. The one or more non-planar regions are shaped to cause a separation of two nested blanks when the two nested blanks are moved relative to each other in a direction at right angles to the stack, the separation being sufficient in amount to overcome any mutual adhesion of the two nested blanks caused by exclusion of air or surface tension between the blanks.

Another exemplary embodiment provides a method of supplying individual container blanks to an apparatus for converting the blanks to container bodies by drawing and ironing procedures. The method comprises forming a nested stack of container blanks, advancing the stack of blanks longitudinally towards a delivery station for delivery of individual blanks to the apparatus and, immediately upstream of the delivery station, causing the stack to follow an inclined surface whereby nested blanks are moved relative to each other in a direction generally at right angles to the stack. The individual container blanks are as defined above.

Yet another exemplary embodiment provides an apparatus for feeding container blanks individually from a stack of such blanks. The apparatus comprises a nested stack of identical container blanks as defined above, a drive element for advancing the stack towards a point of delivery of individual blanks from the stack, a guide for guiding the stack of container blanks towards the point of delivery, the guide having a supporting surface with a first part that maintains the stack in nested form as the stack is advanced, and a second part adjacent to the point of delivery that causes container blanks of the stack to tilt and move at right angles to the stack as the stack is advanced, thereby causing container blanks to separate from each other as the blanks pass over the second part of the surface, and an individual blank feeder that separates individual blanks from the stack at the point of delivery.

The delivery of metal blanks packaged together in the form of sleeves, as opposed to the delivery of metal coils, can save as much as 20% in weight, and avoids the need to return or dispose of waste materials.

### BRIEF DESCRIPTION OF THE DRAWINGS

FIGS. 1A and 1B are, respectively, a cross-sectional view and a top plan view of a container blank according to one exemplary embodiment of the present invention;

FIG. 2A shows two blanks of according to FIGS. 1A and 1B nested together as fully as possible, and FIG. 2B is an enlargement of part of FIG. 2A;

FIG. 3 is a vertical cross-section of a stack of blanks of the kind shown in FIGS. 1A and 1B;

FIGS. 4A, 4B and 4C are cross-sectional views of a pair of blanks of the kind shown in FIGS. 1A and 1B, respectively showing steps in the separation of the blanks as the blanks move from support on a horizontal to an inclined surface;

FIG. 4D is an enlargement of the part of FIG. 4B within the dashed circle;

FIG. 5 is a cross-section of a feed apparatus for container blanks of the kind shown in the preceding figures; and

FIGS. 6, 7 and 8 are cross-sections showing examples of alternative designs of the metal blanks.

### DETAILED DESCRIPTION OF THE EXEMPLARY EMBODIMENTS

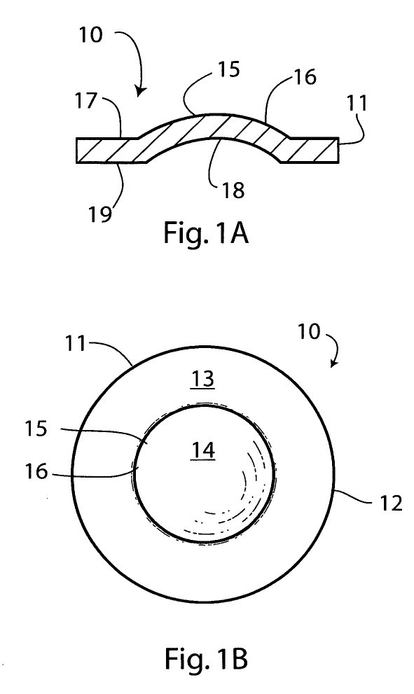

FIGS. 1A and 1B are, respectively, a cross-sectional view and a top plan view of one possible form of a container blank according to an exemplary embodiment of the present invention. The blank 10 consists of a sheet 11 of an aluminum alloy conventionally used for the formation of container bodies (e.g. alloy AA3104 or AA3004), but it may alternatively be made from another metal, such as steel. The sheet may have a gauge or thickness normally employed for container blanks intended for draw and iron steps (e.g. more than 0.003 to 0.080 inches, more preferably 0.007-0.080 (0.178-2.03 mm), 0.006 to 0.10 inches, and even more preferably 0.009 to 0.025 inches (0.229-0.635 mm)). Basically, the gauge should preferably not be so thin that the blanks are not self-supporting when standing on edge (e.g. thin household foil) nor so thick that the blanks do not nest to a significant extent (e.g. thick plate). The blanks may have a diameter typical for blanks intended for the draw and iron process (e.g. 3 to 24 inches (7.6-61 cm) or larger, more preferably 4.5 to 8 inches (11.4-20.3 cm)). The blank may be uncoated or, alternatively, coated with a thin layer (not shown) of liquid, wax or solid material typically provided for surface protection. Such materials may be, for example, light mineral oil, carnauba wax, dried-on water- or solvent-based coatings, or semi-solids such as petrolatum The illustrated blank has a circular periphery 12, a planar peripheral region 13, and a non-planar inner region 14 surrounded by the peripheral region 13. As can be seen best from FIG. 1A, the inner region 14 has a deformation 15 in the form of a dome-shaped projection 16 extending from one side 17 of the blank and a corresponding bowl-shaped central depression 18 extending into the opposite side 19 of the blank. The dome-shaped projection 16 and corresponding depression 18 may be formed simultaneously by punching a correspondingly-shaped tool into the center of a flat circular pre-blank stamped from a continuous flat metal sheet. This is preferably done in such a way that the thickness of the sheet remains essentially the same in all parts of the blank, although a degree of bulge-thinning (e.g. 0-20%, more preferably 3-6%) may be acceptable in some applications (e.g. to save metal). It will be appreciated that the projection and the depression are inwardly ramped at least around the edges thereof. In other words, the projection and depression have parts that slope at an angle to the planar region as the center of the blank is approached from the periphery, although the angle changes slightly according to the exact position due to the curvature of the projection and depression. The effect of this inward ramping or angle of slope will be apparent below.

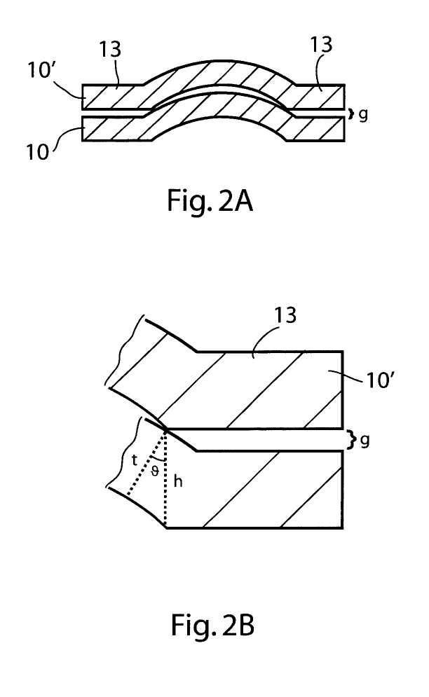

When one such blank 10′ is positioned on top of an identical blank 10 (as shown in FIG. 2A), the blanks do not nest completely together, although the projection of one blank extends partially into the depression of the other blank so a good degree of nesting is achieved. The thickness of the material of the blank means that the length of the arc represented by the underside of the dome-shaped projection 16 (i.e. the depression 18) will be slightly smaller than the length of the arc on the upper side of the dome-shaped projection 16. As a consequence, contact between adjacent blanks will occur in a line at positions around the dome-shaped projections and the edges of the depressions, as can be seen from FIG. 2A. The peripheral regions 13 are therefore spaced apart by a small gap “g”. The degree of this spacing is dependent on the thickness of the material and the degree of slope (i.e. the ramping effect) of the dome-shaped projections 16 adjacent the edges thereof (the parts where the projections merge with the peripheral regions 13. For example, as shown in FIG. 2B, the dimension of the gap “g” is the difference between the vertical height (h) through the material of the blank at the points where the blanks meet (where the angle of slope is 0), and the thickness of the material (t) measured at right angles to the surface, i.e.:

g=h−t

but Cos θ=t/h

therefore h=t/Cos θ

and so g=t/Cos θ−t

or g=t(1/Cos θ−1).

It is therefore possible to calculate such gaps for any known design of container blank of known thickness and degree of slope of the projection. For thicknesses of sheet material commonly employed for container blanks, the gap is often in the region of 0.1 mm, but may be more or less. This may not be sufficient in itself to “break the vacuum” between adjacent container blanks, and even so, a tight contact between the blanks tends to isolate a pocket of air between the inner regions of the blanks that may itself resist separation of the blanks due to the effects of air pressure. However, the design of the blanks facilitates their separation, as explained in the following.

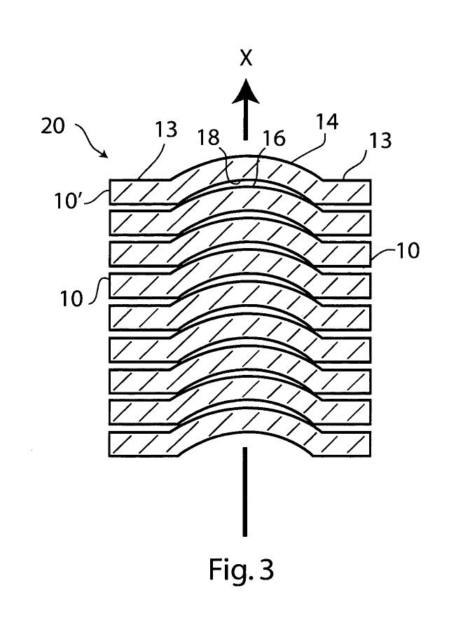

The blank 10 shown in FIGS. 1A and 1B may be stacked with identical blanks as shown in FIG. 3 to form a stack 20 of blanks that may continue for any length in a longitudinal direction as represented by arrow X, for example when used as a feed for a container-making apparatus. Eventually, it will be necessary to remove a blank 10′ from the top of the stack and this is often done by sliding the blank in a sideways direction generally at right angles to the longitudinal direction X of the stack. As the blank 10′ is moved from the top of the stack in this way, the abutment between the depression 18 of the blank being removed and the projection 16 of the one immediately below it causes the uppermost blank to rise slightly from the stack (in this orientation) and thus breaks any adhesion that has formed between the blanks. Air can then rush in between the blanks to equalize pressure. This is explained in more detail in the following.

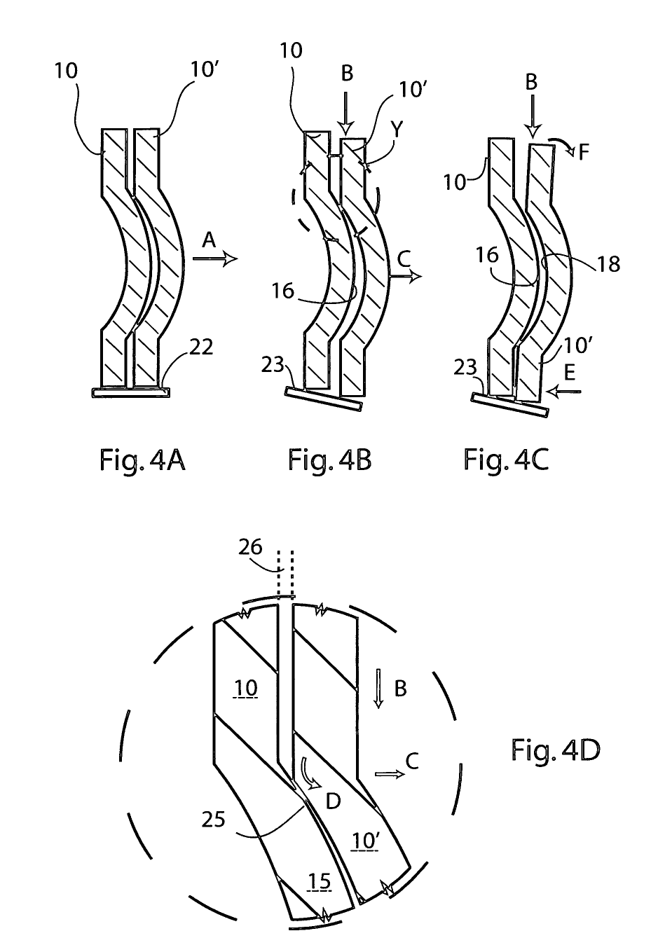

FIGS. 4A, 4B and 4C of the accompanying drawings show a pair of container blanks 10 and 10′ of the same design as shown in FIGS. 1A and 1B. Although only two representative blanks are shown, these blanks may form part of a stack of the kind shown in FIG. 3. In FIG. 4A, the blanks are shown orientated with their central axes horizontal and supported at their lowermost edges on a horizontal surface 22 that may form part of a feed apparatus for the blanks. In this position, the blanks 10 and 10′ are closely nested together but with peripheral gaps as explained above. In FIG. 4B, the blanks have been moved in the direction of arrow A to a sloping support surface 23. The leading blank 10′ descends under the effect of gravity or an external force (as represented by arrow B) to a lower position than that of trailing blank 10. This movement is primarily sideways motion at right angles to the central axis of the stack of blanks (direction X of FIG. 3). However, this movement is resisted by the physical inter-engagement or abutment of the projections and depressions of the blanks, but is made possible if the leading blank 10′ slides forwards over the upper end of the dome-shaped projection 16 of the trailing blank 10. This causes the blanks to separate from each other as indicated by arrow C. This effect is shown in more detail in FIG. 4D which is an enlarged view of the region of FIG. 4B shown by dotted circle Y. As shown, the angled upper part 25 of the dome-shaped projection 16 of the trailing blank 10 acts as a ramp that causes the leading blank 10′ to slide forwards as it moves down past trailing blank 10. This is represented by arrow D and leads to an increased separation of the blanks to a distance 26 (which is larger than gap g of FIG. 2B). Clearly, the greater the distance by which the leading blank 10′ descends, the greater will be the horizontal separation of the blanks (to a maximum distance at which blank 10′ clears the peak of the dome-shaped projection 16 of the trailing blank 10). For the purposes at hand, the separation 26 need only be sufficient to overcome any tendency of the blanks to stick together due to air pressure or surface tension so that the leading blank may be separated from the stack without difficulty. This amount of separation may in practice be quite small. Consequently, advancing a nested stack of blanks along a sloping or inclined surface (inclined relative to the longitudinal direction of the stack) enables the blanks to be separated more easily than would otherwise be the case, so that blanks may be removed from the stack one-by-one at the leading end for feeding to additional processing apparatus. It is found that if the angle of slope at the edges of the projection and depression exceed about 60 degrees, the desired ramping effect of one blank riding over another may not be smoothly attained in some cases, so it is preferred to use smaller angles. On the other hand, the degree of slope is preferably steep enough that a sufficient degree of increased separation of the blanks is achieved with relatively little sideways motion of one blank relative to another. Preferred angles are therefore in the range of 10 to 50 degrees and, more preferably, 20 to 45 degrees. Clearly, the ramping effect or angle of slope is important only until sufficient separation is achieved to break the adhesion between the blanks, so it is generally only the edges of the projection and depression that need to be ramped. The remainder of the depression or projection could be “flat-topped” without detriment to the desired effect, although this is not usually preferred.

The illustrated blanks are also shaped to allow a degree of mutual tilting if or when desired. This is shown in FIG. 4C which illustrates essentially the same situation as FIG. 4B; however, in this case, the lower edge of blank 10′ has been restrained against forward movement by a force indicated by arrow E. This force may be imposed, for example, by abutment with the lower end of another blank (not shown) further along in the stack, or simply by friction generated by the contact with the surface 23. The desired descent of the blank 10′ along the surface 23 is nevertheless made possible by additional forward movement, i.e. tilting, of the upper edge of the blank 10′ as represented by arrow F. In other words, the blank 10′ rotates slightly relative to blank 10, and this rotation is facilitated by the approximate “ball and socket” character of the dome-shaped projection 16 of blank 10 and the central depression 18 of blank 10′. It cannot be said that the central depression 18 pivots precisely around the dome-shaped projection 16, but the similarly-shaped surfaces permit an easy rotation of the blank 10′ over the projection of blank 10 to provided increased separation of the blanks at their upper edges. This tilting action also tends to break any adhesion between the blanks. This tilting effect may be amplified in a manner described below and used to separate the upper edges of the blanks even more, thereby further facilitating feeding of the blanks to additional equipment.

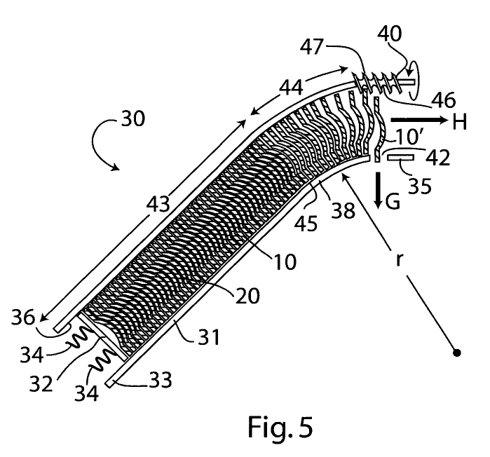

FIG. 5 illustrates, in longitudinal cross-section, a blank feeding apparatus 30 employing container blanks of the kind shown in FIGS. 1A and 1B. The apparatus comprises an upwardly-inclined cylindrical chute 31 having a movable pusher plate 32 initially positioned at the lower or feed end 33 of the chute. The plate is urged under the force of spring elements 34 along the chute towards the upper or delivery end 35. A stack 20 of container blanks 10 is supported on the pusher plate, and the stack is also urged to move towards the upper end 35 of the chute. Inner walls 36 of the chute 31 encircle the stack with only a small amount of clearance and therefore keep the container blanks 10 of the stack in a centered and nested condition for the majority of the distance of travel from the lower end 33 to the upper end 35 of the chute under the drive provided by pusher plate 32. However, adjacent to the upper end 35, the chute incorporates a bend 38 following a radius r. Note that a smaller value of r will produce a larger degree of separation of the blanks at the bend 38 as the inclination of the supporting surface constantly increases. A rotating screw feed element 40 is positioned immediately beyond the upper end 35 of the chute to meter out individual blanks 10 from the upper end of the chute at a regular rate. The individual blanks 10 emerging from the open upper end 35 of the chute descend under gravity or an external force through a slot 42 in the lower side of the chute 31 as shown by arrow G, and are then delivered to other apparatus, normally an apparatus for converting the blanks into container bodies.

As indicated above, the blanks 10 of the stack 20 remain concentric and nested in linear part 43 of the chute 31. As they encounter curved part 44, the lower surface 45 of the chute, which is both inclined at an angle relative to the linear part and gently curved towards the horizontal, causes the container blanks 10 to move to a certain extent at right angles to the linear axis of the stack in the manner shown in FIG. 4C, thus causing the blanks to separate from each other at their upper ends sufficiently to eliminate any tendency of the blanks to stick together. The separation is in the form shown in FIG. 4C rather than FIG. 4A because the bend 38 in the chute causes the lower edges of the blanks to crowd together, thus forcing the blanks to tilt. This tilting effect is enhanced by the curvature of the surface 45, so the spacings at the upper ends of the blanks gradually increases as the blanks negotiate the curved part 44 of the chute, as shown. This presents the blanks perfectly for engagement by the feed 40 which receives the upper edges between loops 46 of screw thread 47. The endmost blank 10′ is therefore pulled from the stack in direction of arrow H at a precise speed and distance from the blank next-in-line, and is thus delivered to the slot 42 at a measured interval from the preceding blank fed in the same manner. The blank feeding apparatus 30 thus makes use of both the separation and tilting effects of the exemplary embodiment (to eliminate mutual adhesion of the blanks), and an enhanced or amplified tilting effect to create a sufficient gap between blanks on the upper side of the stack to allow mechanical feeding device 40 to enter between the blanks and to feed them from the apparatus in a precise manner. The degree of tilting required to achieve good separation may be in the range of 1 to 45 degrees, and more preferably 15 to 35 degrees.

When all the blanks have been fed from the chute in this way, the pusher plate 32 may be returned to the lower end 33 of the chute 31, withdrawn, and a new stack 20 of blanks inserted.

Although the chute 31 is shown in an upwardly inclined position from the feed end to the delivery end, this arrangement may be reversed and the stack may be fed downwardly. In such a case, the blanks may be removed from the stack by means of a mechanical pusher (not shown) employing rotating wheels or belts engaging the edges of the blanks.

In the above embodiments of the container blank as shown in FIGS. 1A and 1B, there is just one planar peripheral region 13 (an annular region adjacent to the periphery of the blank) and just one non-planar inner region 14 (a deformation 15 positioned centrally of the blank). The deformation diameter in this exemplary embodiment may occupy 10-90% of the diameter of the blank, more preferably 25 to 65% of the blank diameter, and the deformation depth is preferably in the range of 2 to 25% of the blank diameter and more preferably 4 to 12%. This is particularly preferred because the dome-shaped projection may be sized and shaped to correspond to the inward-facing dome employed at the bottom of conventional beverage cans, and the planar peripheral regions may be dimensioned to form the container walls. As indicated earlier, in the traditional draw and iron process, a circular blank is cut from a flat sheet and then immediately drawn into a flat-bottomed cup. The cup is then transferred to a body-maker machine where the cup is redrawn to a smaller diameter and the side walls thinned and elongated by ironing. Finally, the bottom wall is inwardly domed by forcing the bottom of the container onto a suitably-shaped punch or tool set, thereby bowing the bottom wall inwards. By using a blank of the kind shown in FIG. 1A or FIG. 1B, it may be possible to eliminate the final step, or at least to pre-shape the bottom wall to approximate the shape of the bottom wall of the eventual container so that only minimal final shaping is then required. The shape of the projection may be specific to a particular design of beverage can, or more preferably, it may be generic to a number of different container designs of the same general type and size.

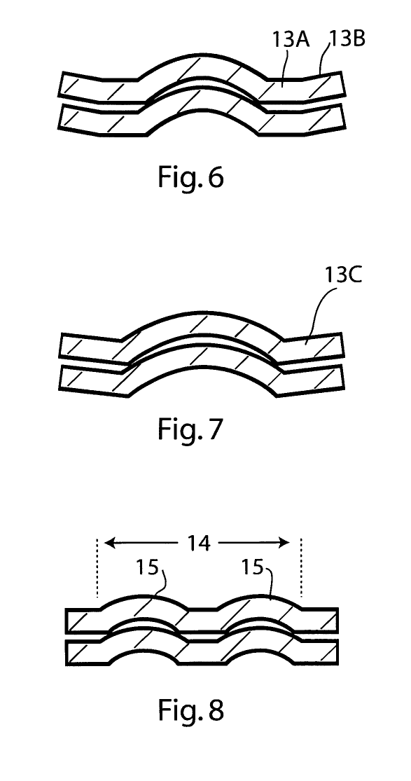

While the above design is preferred for the reasons given, blanks of other designs may be provided. Examples are shown in FIGS. 6, 7 and 8, each of which shows two nested identical blanks. In FIG. 6, the peripheral region 13 of each blank has a planar section 13A and an upwardly ramped section 13B. In FIG. 7, the peripheral region 13C is not planar at all, but is gently ramped. These two designs may be desirable to facilitate the initial cupping step of the draw and iron process in which the peripheral regions are bent upwardly to form the container walls. The ramped sections represent an initial bend in the blank in the right direction that may make the cupping step easier or better. So far, all of the illustrated blanks have had a symmetrically-centered deformation so that when the blanks are stacked, they nest easily together without having to be precisely oriented, one to the other. In the case of FIG. 8, however, the inner region 14 has four small deformations 15 (only two being shown in the cross section). Such a design would still be nestable, but would prevent nested blanks from rotating relative to each other and this may be advantageous in some circumstance.

Furthermore, it should be mentioned that blanks intended for the draw and iron process are generally circular, but they may, in some circumstances, be of other shapes, e.g. oval. In such cases, a central deformation corresponding in shape to the periphery of the blank would normally be provided.

While the exemplary embodiments have related to blanks intended primarily for beverage containers, similar blanks may also be produced for containers of other kinds, e.g. metal bottles and aerosol canisters, etc. Similarly, blanks intended for draw and iron processes have been described, but similar blanks for other shaping methods, e.g. draw and redraw, metal blow molding, etc., may also be produced.

1. A metal blank for conversion into a container body, the blank comprising a sheet of metal of having a peripheral region adjacent a periphery of the sheet and an inner region surrounded by the peripheral region, wherein said inner region has at least one deformation forming a projection on one side of the sheet and a correspondingly-shaped depression in an opposite side of the sheet, said projection and depression being inwardly ramped at least around edges thereof whereby, when said blank is tightly nested with an identical blank, said at least one projection of one blank extends partially into said at least one depression of the other, and whereby relative sideways movement of the blanks causes one of said blanks to tilt relative to the other or to move further away from the other due to abutment of said ramped projection and said depression, thereby increasing a gap between said peripheries of the blanks sufficiently to break any mutual adhesion between the blanks caused by air pressure or surface tension.

2. The blank of claim 1, wherein said at least one projection is dome-shaped.

3. The blank of claim 1, wherein said peripheral region is planar.

4. The blank of claim 1, wherein said peripheral region includes a planar part and a ramped part.

5. The blank of claim 1, wherein said peripheral region is ramped.

6. The blank of claim 1, wherein said periphery is circular.

7. The blank of claim 1, having a single dome-shaped projection.

8. The blank of claim 1, wherein said metal sheet is coated with a material that promotes said mutual adhesion.

9. The blank of claim 1, wherein said projection is inwardly ramped around said edges at an angle of up to 60 degrees.

10. The blank of claim 1, wherein said thickness is in a range of 0.007 to 0.080 inch.

11. The blank of claim 1, wherein the metal is selected from the group consisting of steel and alloys of aluminum.

12. The blank of claim 7, wherein said dome shaped deformation has dimensions effective to form an inwardly-cupped bottom wall of a container body after said blank undergoes metal drawing and ironing procedures effective to convert said peripheral region to walls of said container body.

13. A metal blank for conversion into a container body by metal drawing and ironing procedures, the blank comprising a sheet of metal having one or more planar regions and one or more non-planar regions, the sheet being nestable with identical blanks to form a nested stack of said blanks, said one or more non-planar regions being shaped to cause a separation of two nested blanks when said two nested blanks are moved relative to each other in a direction at right angles to said stack, said separation being sufficient in amount to overcome any mutual adhesion of said two nested blanks caused by exclusion of air or surface tension between said blanks.

14. The blank of claim 13, wherein said one or more non-planar regions are also shaped to tilt said two blanks relative to each other upon said mutual movement so that said separation is greater on one side of said stack than an opposite side of said stack.

15. The metal blank of claim 13, wherein said one or more planar regions comprises a continuous planar region adjacent to a periphery of said blank, and said one or more non-planar regions comprises a central dome-shaped projection extending from one side of the blank and a corresponding central depression extending into an opposite side of the blank.

16. The metal blank of claim 15, wherein said periphery is generally circular.

17. The metal blank of claim 15, wherein said central dome-shaped projection and corresponding depression have shapes and dimensions adapted to form an inwardly-cupped bottom wall of a container body after said blank undergoes metal drawing and ironing procedures effective to convert said continuous planar region to walls of said container body.

18. The metal blank of claim 13 wherein said sheet of metal has essentially the same gauge in both said one or more planar regions and said one or more non-planar regions.

19. The metal blank of claim 18 made of aluminum or an aluminum alloy and said gauge is an effective gauge for container body formation.

20. The metal blank of claim 13, wherein any amount of movement of said two nested blanks relative to each other in said direction at right angles to said stack commences said separation of said two blanks.

21. The metal blank of claim 13 further comprising a coating of a liquid.

22. The metal blank of claim 21 wherein said liquid is a light oil.

23. A method of supplying individual container blanks to an apparatus for converting said blanks to container bodies by drawing and ironing procedures, which method comprises forming a nested stack of identical container blanks as defined in claim 1, advancing said stack of blanks in an axial direction of the stack towards a delivery station for delivery of individual blanks to said apparatus and, immediately upstream of said delivery station, causing said stack to follow a surface that is inclined relative to said axial direction of the stack, whereby nested blanks of said stack are moved relative to each other in a direction generally at right angles to said axial direction, thereby breaking mutual adhesion between said blanks caused by air pressure or surface tension before delivery thereof to said apparatus.

24. The method of claim 23, wherein said inclined surface is also made to follow a surface having a curve such that said blanks are tilted relative to each other as said blanks are advanced along said surface, thereby increasing said separation of said blanks at one side of the stack relative to the other.

25. The method of claim 24, wherein said blanks are engaged at said delivery station by a rotating element having a spiral thread, said thread entering gaps between said blanks at said one side of the stack and metering delivery of said blanks to said apparatus according to a speed of rotation of the element.

26. Apparatus for feeding container blanks individually from a stack of such blanks, said apparatus comprising:
a feeder for holding and guiding a plurality of identical container blanks as defined in claim 1 as a nested stack having a longitudinal axis;
a drive element for advancing said stack along said feeder towards a point of delivery of individual blanks from the stack; and
an individual blank metering device that separates blanks from the stack at said point of delivery;
wherein said feeder includes a supporting surface for said stack with a first part that maintains said blanks in alignment with said longitudinal axis of said stack, and a second part adjacent to said point of deliver that causes said blanks of the stack to move at right angles to said longitudinal axis as said stack is advanced, thereby causing container blanks to lose mutual adhesion and separate from each other as said blanks pass over said second part of said surface.

27. The apparatus of claim 26, wherein said second part of the surface is arcuate, thereby causing said blanks to tilt relative to each other as said blanks are advanced over said second part of the surface, thereby separating the blanks further at one side of the stack and facilitating removal of said blanks by said individual blank feeder.
